(19) United States
(12) Patent Application Publication
(10) Pub. No.: US 2012/0325043 A1
(43) Pub. Date: Dec. 27, 2012

(54) DAMPING DEVICE

(75) Inventor: CHIEN-HAO LU, Tu-Cheng (TW)

(73) Assignee: HON HAI PRECISION INDUSTRY CO., LTD., Tu-Cheng (TW)

(21) Appl. No.: 13/268,037

(22) Filed: Oct. 7, 2011

(30) Foreign Application Priority Data
Jun. 24, 2011 (TW) 100122351

(51) Int. Cl. G05G 5/06

(52) U.S. Cl. 74/527

(57) ABSTRACT

A damping device includes a base and an arm. The base includes a base board and a cantilever located on the base board. The arm is pivotably mounted to the base board about a pivot axis. The arm is rotatable from a first position to a second position. The cantilever is urged and is resiliently deformed away from the pivot axis. A distance between the pivot axis and a contact surface, which is between the arm and the cantilever at the first position is smaller than that in the second position.

### BACKGROUND

1. Technical Field

The present disclosure relates to damping devices, especially to a damping device used with a rotatable arm.

2. Description of Related Art

Some mechanisms have block device or damping device for stopping a moving linkage. For example, a printer may include an enclosure and a rotatable front cover on the enclosure. A stop tab located inside or outside the enclosure may block the front cover, when the front cover is rotated out of the enclosure. However, the front cover is blocked rigidly by the stop tab and may be damaged when rapidly moved. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a damping device in one embodiment.

FIG. 2 is similar to FIG. 1, but showing the damping device from FIG. 1 from another aspect.

FIG. 3 is an assembled view of the damping device of FIG. 1.

FIG. 4 is an assembled view of the damping device of FIG. 2, and is another aspect of the damping device of FIG. 3.

FIG. 5 is a plan view of the damping device of FIG. 1, and an arm of the damping device is in a first position.

FIG. 6 is similar to FIG. 3, but the arm of the damping device is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

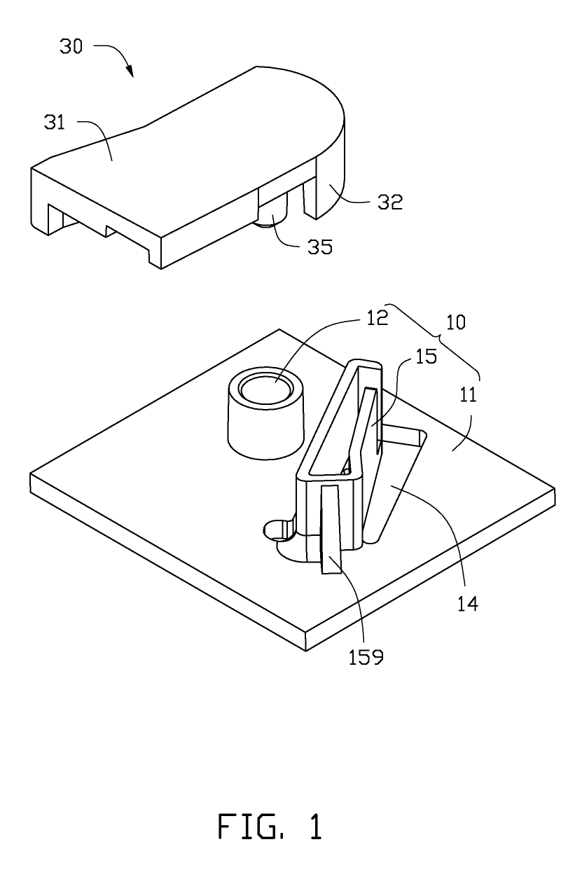

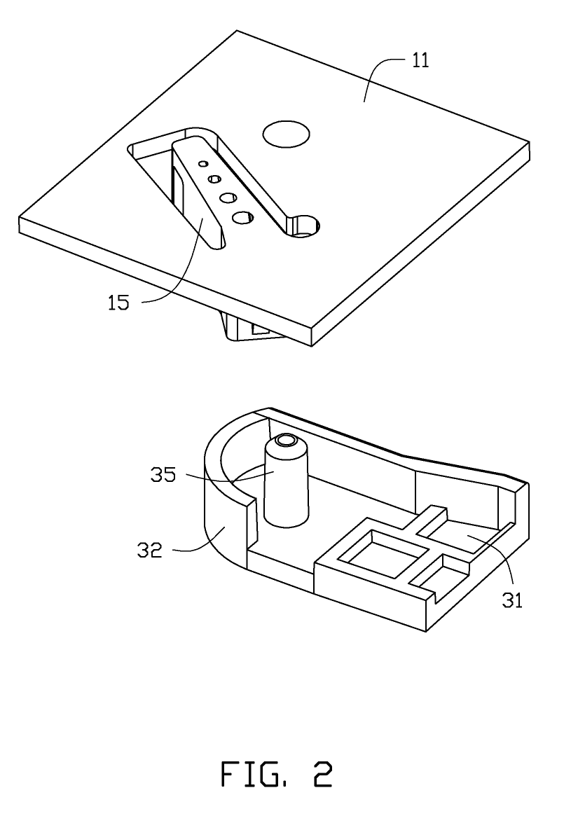

Referring to FIG. 1 and FIG. 2, in one embodiment, a damping device is provided to slow a moving or rotating arm. The damping device includes a base 10 and an arm 30 mounted on the base 10. The base 10 and the arm 30 may be made of plastic.

The base 10 includes a base board 11, a pivot portion located on the base board 11, and a cantilever 15. The base 10 may be integral. The base board 11 defines an opening 14 for receiving the cantilever 15 and provides a moving space for the cantilever 15.

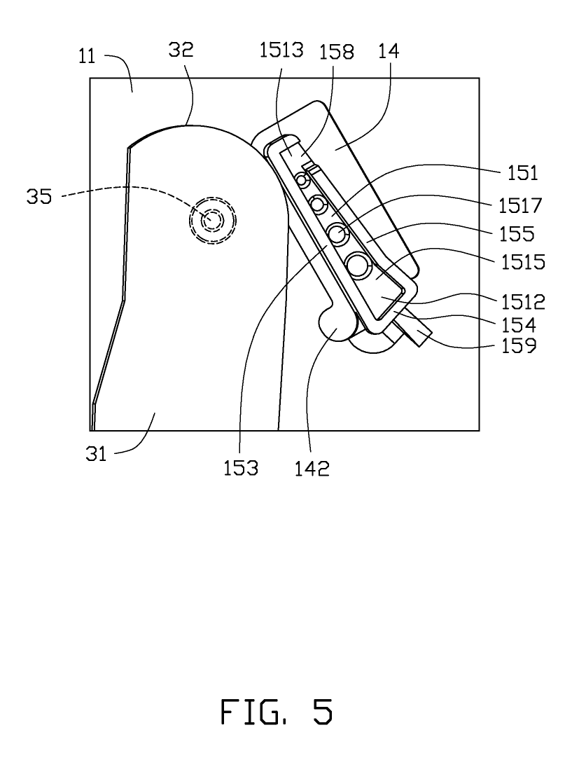

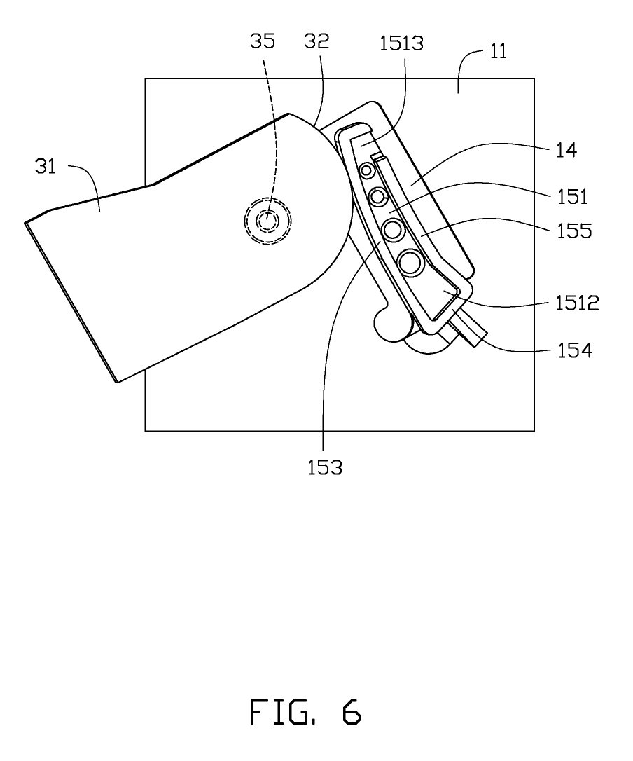

Referring to FIG. 5 and FIG. 6, the cantilever 15 includes a bottom wall 151, a contact wall 153, a connecting wall 154, and a side wall 155. The contact wall 153, the connecting wall 154, and the side wall 155 are located on edges of the bottom wall 151. The contact wall 153, the connecting wall 154, and the side wall 155 are perpendicular to the bottom wall 151 and are connected in sequence.

The bottom wall 151 includes a free distal end 1513, an extending portion 1515, and a connecting portion 1512 connecting to the base board 11. The extending portion 1515 is located between the connecting portion 1512 and the distal end 1513. The extending portion 1515 is substantially tapered along a direction from the connecting portion 1512 to the distal end 1513. The width of the distal end 1513 is smaller than that of the connecting portion 1512. The bottom wall 151 and the base board 11 may be located at a same plane.

At least one through hole 1517 is defined in the bottom wall 151 for facilitating deformation of the cantilever 15. In one embodiment, four through holes 1517 may be defined. The diameters of the four through holes 1517 are tapered along the direction from the connecting portion 1512 to the distal end 1513.

The connecting wall 154 is located on the connecting portion 1512. The bottom wall 151, the contact wall 153, the connecting wall 154, and the side wall 155 cooperatively define a space (not shown). The space may be enclosed along a plane parallel to the base board 11. In one embodiment, the space may be opened by a cutout 158 defined in the side wall 155 at the distal end 1513. The cutout 158 communicates with the space. The cantilever 15 further includes a strengthen portion 159 connecting to the side wall 155.

The area of the opening 14 is larger than that of the bottom wall 151. A configuration hole 142 is defined in the base board 11 adjacent to the connecting portion 1512. The deformation force of the cantilever 15 may be affected by the diameter of the configuration hole 142. The diameter of the configuration hole 142 may be adjusted depending on requirement of the deformation force of the cantilever 15.

A pivot portion 12 protrudes from the base board 11. The pivot portion 12 has a hollow column configuration.

The arm 30 includes a linkage 31, a post 35 protruding from the linkage 31, and an outer surface 32 located on the distal end of the linkage 31 to engage with the cantilever 15. The post 35 may engage with the pivot portion 12 to pivot the linkage 31 about an axis extending through the post 35. In one embodiment, the outer surface 32 is curved. The outer surface 32 serves as a cam to urge the cantilever 15.

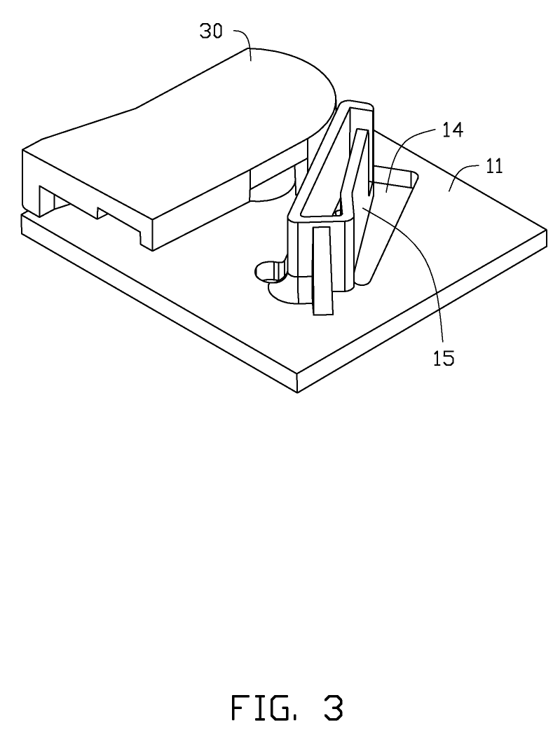

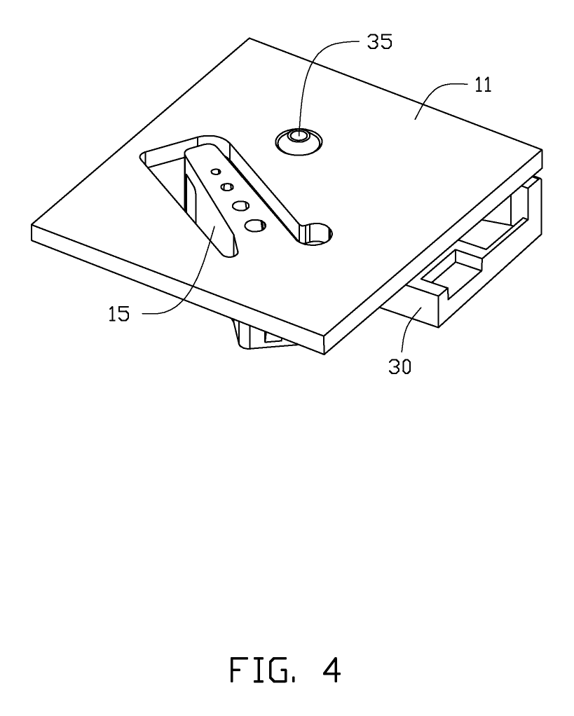

Referring through FIG. 3 to FIG. 6, in assembly, the arm 30 is pivotally mounted to the base 10 with the post 35 engaged in the pivot portion 12. The linkage 31 pivots about the axis. The outer surface 32 may contact the contact wall 153.

In use, the arm 30 can be rotated from a first position to a second position to urge the cantilever 15 to resiliently deform away from arm 30. A first distance between the pivot axis and a first contact surface, which is between the arm 30 and the cantilever 15 at the first position is smaller than a second distance between the pivot axis and a second contact surface which is between the arm 30 and the cantilever 15 in the second position. Resilient force of the cantilever 15 at the second position is larger than that in the first position. In this way, the cantilever 15 can gradually stop the rotating arm 30.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A damping device, comprising:
a base comprising a base board and a cantilever located on the base board; and
an arm pivotably mounted to the base board about a pivot axis;
wherein the arm is rotatable from a first position to a second position, the cantilever is urged and resiliently deformed away from the pivot axis, and a distance between the pivot axis and a contact surface which between the arm and the cantilever at the first position is smaller than that in the second position.

2. The damping device of claim 1, wherein the cantilever comprises a bottom wall and a contact wall in contact with the arm, the contact wall is perpendicular to the bottom wall, and the bottom wall and the base board are substantially located at a same plane.

3. The damping device of claim 2, wherein the bottom wall comprises a distal end, a connecting portion connecting to the base board, and an extending portion between the connecting portion and the distal end; and the extending portion is substantially tapered from the connecting portion to the distal end.

4. The damping device of claim 2, wherein at least one through hole is defined on the bottom wall.

5. The damping device of claim 2, wherein an opening is defined in the base board to receive the cantilever, and an area of the opening is larger than that of the bottom wall.

6. The damping device of claim 2, wherein the cantilever further comprises a connect wall perpendicular to the bottom wall and a side wall perpendicular to the bottom wall;
and the bottom wall, the contact wall, the connect wall, and the side wall corporately define a space.

7. The damping device of claim 6, wherein the contact wall, the connect wall and the side wall are located at edges of the bottom wall.

8. The damping device of claim 6, wherein a side cutout is defined in the side wall, and the side cutout communicates with the space.

9. The damping device of claim 1, wherein the cantilever is integral with the base board.

10. The damping device of claim 1, wherein the arm comprises a curved outer surface contacting the cantilever.

11. A damping device, comprising:
a base comprising:
a base board; and
a cantilever located on the base board, the cantilever comprising a bottom wall and a contact wall, the contact wall substantially perpendicular to the base board, the bottom wall comprising a free distal end, a connecting portion connecting to the base board, and an extending portion between the connecting portion and the free distal end;
wherein the extending portion is substantially tapered extending from the connecting portion to the distal end.

12. The damping device of claim 11 further comprising an arm; wherein the arm is pivotably mounted to the base board about a pivot axis, the arm is rotatable from a first position to a second position; and the cantilever is urged and resiliently deformed away from the pivot axis, and a distance between the pivot axis and a contact surface which between the arm and the cantilever at the first position is smaller than that in the second position.

13. The damping device of claim 12, wherein the arm comprises a curved outer surface in contact with the cantilever.

14. The damping device of claim 11, wherein the bottom wall and the base board are substantially located at a same plane.

15. The damping device of claim 11, wherein at least one through hole is defined in the bottom wall.

16. The damping device of claim 11, wherein an opening is defined in the base board to receive the cantilever, and an area of the opening is larger than that of the bottom wall.

17. The damping device of claim 11, wherein the cantilever further comprises a connect wall perpendicular to the bottom wall and a side wall perpendicular to the bottom wall; and the bottom wall, the contact wall, the connect wall, and the side wall corporately define a space.

18. The damping device of claim 17, wherein the contact wall, the connect wall and the side wall are located at edges of the bottom wall.

19. The damping device of claim 17, wherein a side cutout is defined in the side wall, and the side cutout communicates with the space.

20. The damping device of claim 11, wherein the cantilever is integral with the base board.
